(19) United States
(12) Patent Application Publication
(10) Pub. No.: US 2005/0237305 A1
(43) Pub. Date: Oct. 27, 2005

(54) Tactile feedback through a computer keyboard

(76) Inventor: Udo Klein, Maximiliansau (DE)

Correspondence Address: FISH & RICHARDSON, P.C., PO BOX 1022, MINNEAPOLIS, MN, 55440-1022, US

(21) Appl. No.: 10/832,580

(22) Filed: Apr. 27, 2004

(51) Int. Cl. G09G 5/00

(52) U.S. Cl. 345/168

(57) ABSTRACT

Tactile feedback may be provided through a computer keyboard to a user. A method comprises receiving an input that a user makes with a keyboard connected to a computer device. The input causes a predetermined event to occur in the computer device. A predetermined electronic output is made from the computer device upon the predetermined event. The predetermined electronic output provides a tactile feedback to the user through the keyboard. The predetermined electronic output may be provided in the same or a different cable than manages keyboard input to the computer device. The predetermined electronic output may be caused by an application incorporated in, or separate from, a computer keyboard driver application that manages keyboard input to the computer device.

### TECHNICAL FIELD

This description relates to providing tactile feedback to a user through a computer keyboard.

### BACKGROUND

Almost all of today's computer systems or devices include at least one keyboard by which a user can input information. For example, IBM-compatible personal computers may have a special connector, or port, called a PS/2 connector, to which many keyboards available on the market today can be connected. Keyboards that are capable of using the interface required by such computers and ports are sometimes referred to as PS/2 keyboards.

Also, most computer systems provide feedback to a user. That is, when there is a need for the system to alert the user of a certain condition or to confirm that an operation has been performed, these systems can output some form of signal to the user. One common type of feedback is a visual feedback displayed on a display device connected to a computer. A visual feedback may be verbal, such as a written message, or non-verbal, such as an icon or other symbol that appears, or a color change in some feature of the graphical user interface (GUI). Many systems also provide audio feedback, for example through a speaker located inside the computer device or through a speaker external to the computer device.

There are disadvantages, however, with these types of feedback. Not every user looks at the screen when typing on a keyboard, and may therefore miss important visual clues. In those systems where the visual message blocks further input from the keyboard until the user clicks on (or otherwise acknowledges) the visual message, a user who is not watching the screen may inadvertently continue typing while being unaware of the message. In such a situation, important user input may be lost. Audio feedback, in turn, can be irritating to users, especially when the sound is an error signal. Moreover, computer-generated sounds may induce uncomfortable noise in an environment where more than one person is working. When several people are using nearby computers, such as across a desk from each other, it can sometimes be difficult for them to determine whose computer generated the sound. Also, audio feedback may not be useful for persons who do not hear well.

### SUMMARY

The invention relates to providing tactile feedback through a computer keyboard. In a first general aspect, a method comprises receiving an input that a user makes with a keyboard connected to a computer device. The input causes a predetermined event to occur in the computer device. A predetermined electronic output is made from the computer device upon the predetermined event. The predetermined electronic output provides a tactile feedback to the user through the keyboard.

In selected embodiments, the predetermined event is one selected from the group consisting of: an error in the computer device, the user attempting to type more characters than allowed in an input field, the user typing an improper type of character in the input field, the user depressing a key on the keyboard, and combinations thereof.

In a second general aspect, a computer keyboard comprises a housing having a plurality of keys with which a user can make an input when the computer keyboard is connected to a computer device, and a device adjacent the housing for providing a tactile feedback to the user upon a predetermined electronic output from the computer device.

In selected embodiments, the predetermined electronic output is provided in a cable for input from the keyboard to the computer device. In selected embodiments, the predetermined electronic output is provided in a separate cable from a cable for input from the keyboard to the computer device.

The predetermined electronic output may be caused by an application incorporated in, or separate from, a computer keyboard driver application that manages keyboard input to the computer device.

In selected embodiments, the device is one selected from the following group: a motor, an oscillator, a linear actuator, an agitator, and combinations thereof.

In selected embodiments, the device is located in a location selected from the group consisting of: on top of the housing, underneath the housing, on a side of the housing, inside the housing, abutting the housing, and combinations thereof.

Advantages of systems and techniques described herein may include any or all of the following. Providing tactile feedback through a computer keyboard. Improved user feedback from a computer system. Providing computer feedback that is perceived essentially only by one user. Providing feedback through a computer keyboard that is not perceived with vision or hearing. Providing a user feedback that can be perceived without the user looking at a screen. Providing a user feedback that does not generate disturbing noise through a speaker. Providing tactile feedback through a conventional computer keyboard. Providing tactile feedback without modifying a driver application for the computer keyboard.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a block diagram of a system including an embodiment of an inventive computer keyboard;

FIG. 2 is a flow chart of an embodiment of an inventive method;

FIG. 3 is a block diagram including an embodiment of an inventive computer keyboard; and

FIG. 4 is a block diagram of a general computer system.

Like reference numerals in the various drawings indicate like elements.

### DETAILED DESCRIPTION

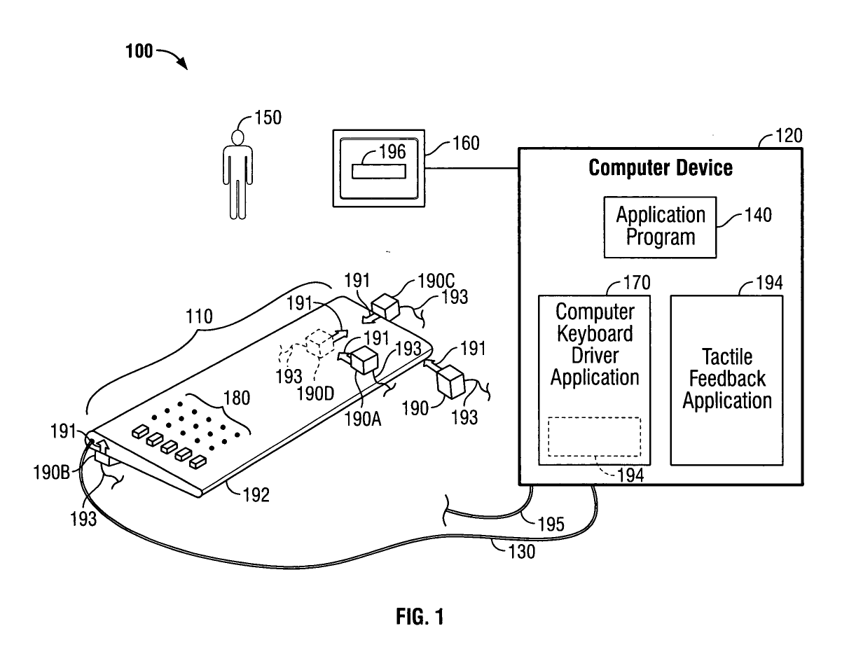

FIG. 1 schematically illustrates a system 100 that can provide tactile feedback through a computer keyboard. The system includes a computer keyboard 110 connected to a computer device 120 through a cable 130. The computer device includes at least one application program 140 that a user 150 can cause to operate in the system, as is well known. The application program may cause the system to generate a GUI on a display device 160 connected to the computer device. User input from the computer keyboard 110 to the computer device may be managed by a computer keyboard driver application (CKDA) 170 as is well known. Essentially, the CKDA may provide an interface between the computer keyboard 110 and the computer device. For example, when the user depresses one or more of keys 180 on the computer keyboard 110, the CKDA may provide that corresponding signals generated by the computer keyboard are received and understood by the computer device.

The computer keyboard 110 may comprise a device 190 for providing tactile feedback to the user. In FIG. 1 the tactile feedback is conceptually indicated by arrow 191. The tactile feedback 191 may include bumping the keyboard, shaking the keyboard, vibrating the keyboard, and combinations thereof. The device 190 may comprise anything that is capable of providing tactile feedback through the computer keyboard, such as an electromechanical device. The device 190 may comprise one or more of a motor, an oscillator, a linear actuator, an agitator or combinations thereof, for example a vibrating device of the type commonly used in cellular telephones, or in joysticks or other video game controls. Depending on its energy consumption, the device 190 may be powered from the same power source that is used for inputting information from the computer keyboard; in general, the computer device. In other implementations, the device 190 may be connected to a separate power source.

The device 190 may be located adjacent a housing 192 of the computer keyboard. There are many different positions relative to the housing 192 from which the device 190 may provide tactile feedback. As additional examples, it may be located on top of (190A) the housing, underneath (190B) the housing, on a side (190C) of the housing, or inside (190D, shown in phantom) the housing. In certain of these and other exemplary positions, the device abuts the housing. In other implementations, the device 190 may be located nearby the housing such that it conveys kinetic energy to the keyboard without touching the housing. In each position, the device provides tactile feedback as indicated by the arrow 191.

The device 190 may provide tactile feedback upon a predetermined electronic output being generated from the computer device. The device 190 may receive the output through any suitable connection, for example a cable 193. A tactile feedback application (TFA) 194 may contain at least one executable instruction that causes the computer device to make the predetermined electronic output upon occurrence of a predetermined event, as will be described.

In some implementations, the output is made through the same cable 130 that manages input from the computer keyboard to the computer device. There may therefore be a connection between the cable 130 and the cable 193. For example, such a connection may be established by connecting the cable 193 to a processor located inside the computer keyboard. Such a processor is connected to the cable 130 to manage the signals sent from the keyboard to the computer device and other functions such as the illumination of a “Caps Lock” indicator light (not shown) on the keyboard, as is well known. By including suitable logic, in such a processor, it can be configured to recognize the predetermined electronic output made by the computer device and, in response thereto, activate the device 190 to provide tactile feedback. It may be necessary to modify the communications protocol that is used between the keyboard processor and the computer device to ensure that the predetermined electronic output can be sent at appropriate times, for example immediately upon one or more predetermined events in the computer device. Accordingly, the computer keyboard 110 may essentially comprise a conventional computer keyboard being provided with the device 190. The fact that there is no separate cable to the device 190 may reinforce the general impression that this is a “regular” keyboard. In these kinds of implementations, the TFA 194 may be incorporated in the CKDA 170, as shown in phantom.

Some same-cable implementations may use the Universal Serial Bus (USB) standard. Assume, for example, that the keyboard connects to the computer device through a USB cable. The USB standard supports connecting many devices to the same port. The USB connection can therefore be divided—preferably at the keyboard end so that the user only needs to insert one plug into the computer—and both the keyboard and the device 190 can be controlled through the USB connection. That is, the USB that is originally intended only for the keyboard can be used both for the keyboard and for the device 190. In some same-cable USB-implementations, the keyboard and the device 190 are identified to the computer device as separate devices. That is, the device 190 can operate independently of the keyboard, which need not be “aware” of it. There may accordingly be no reason to modify a keyboard driver. In other implementations, the two are identified as a single device to the computer device. That is, the keyboard driver in the computer device may be configured such that the operation of the device 190 is integrated in the driver's handling of the keyboard.

In other implementations, the output from the computer device to the device 190 may be made in a separate cable 195. The cable 193 may therefore be connected to the cable 195. The cable 195 may use any suitable connector or port on the computer device, such as a PS/2 port, serial port, parallel port or any kind of USB port. The TFA should be configured such that the proper predetermined electronic output is generated in the port to which the cable 195 is connected. One advantage of such implementations is that tactile feedback may be implemented without using the ordinary keyboard cable and without modifying the keyboard processor. For example, it may be possible to “retrofit” a conventional computer keyboard with the device 190 and connect it to the computer device using the cable 195. In such implementations, there may also be no need to modify the CKDA 170, which may accordingly be “unaware” that any feedback is being provided.

It will now be described some examples of when tactile feedback 191 may be generated. For example, assume that the user makes an input by depressing one of the keys 180 and that this causes an error in the computer device. For example, the input creates an exception or an undefined condition in the application program 140. This is an example of a predetermined event that may warrant tactile feedback to inform the user about the error. Accordingly, the TFA 194 may provide that the computer device makes the predetermined electronic output upon the predetermined event. Upon receiving the predetermined electronic output, the device 190 may provide tactile feedback to the user through the keyboard.

As another example, assume that the user is typing characters into an input field 196 in the GUI of the application program 140. The field 196 in this example is limited to inputting a maximum number of characters. The application program 140 may therefore block the field from further input after the user enters the maximum number of characters. Here, the user is not aware of this restriction, however, and attempts to type more than the allowed number of characters in the field. The user's continued typing causes signals to be transmitted from the keyboard to the computer device. Receipt of these signals may trigger a predetermined event in the computer system that subsequently causes tactile feedback to be generated.

The duration of the tactile feedback may vary. For example, a relatively brief vibration of the keyboard—such as only a fraction of a second—may indicate a condition that is not considered particularly serious. A longer feedback, in contrast, may indicate a problem that perhaps requires use intervention. In some implementations, the keyboard may provide tactile feedback with every keystroke, even in the absence of errors or input blocking in the computer device.

As yet another example, assume that the field 196 is limited to inputting numbers, as opposed to letters or other characters. The application program 140 may therefore block the field from any keyboard input that comprises a non-numerical character. Here, the user is not aware of this restriction, and attempts to type one or more letters in the field. The signal(s) from the keyboard upon the user's typing may trigger a predetermined event in the computer system that subsequently causes tactile feedback to be generated.

The above are merely a few examples of predetermined events that can cause tactile feedback to be generated, and other events may be used in some implementations. Moreover, it may be possible to generate tactile feedback of different intensities. For example, the device 190 may be able to recognize different predetermined electronic outputs that correspond to more or less tactile feedback. That is, for a specific predetermined event the system 100 may select a particular output among multiple predetermined electronic outputs to provide a tactile feedback of desired intensity. For example, a high-intensity feedback may be used for error events, a medium-level feedback for less serious conditions, and a low-level feedback for every keystroke on the computer keyboard 110. Also, the system 100 may provide a convenient way for the person 150 to switch the tactile feedback function on or off; for example, through an input control in the displayed GUI, akin to a “mute” button for a speaker volume.

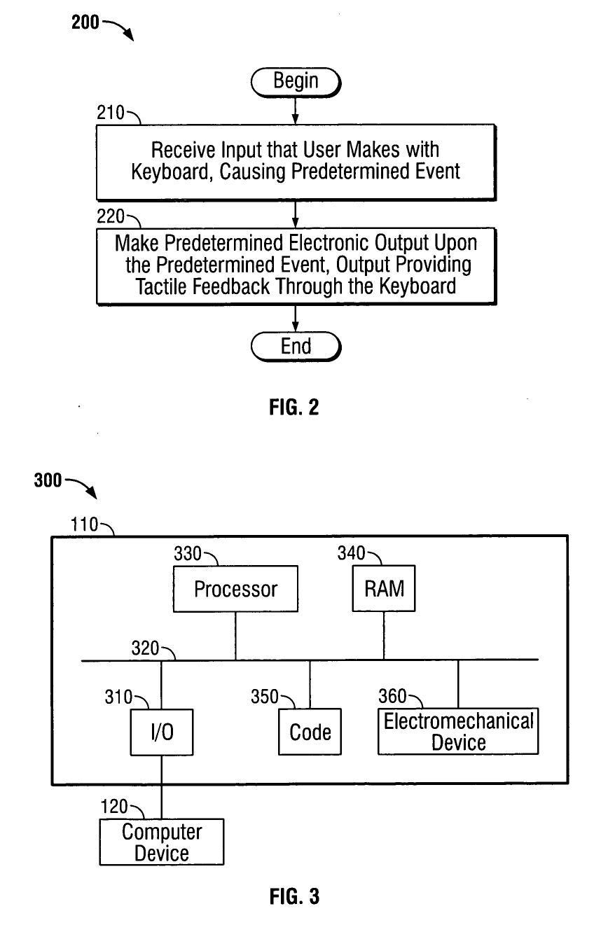

FIG. 2 shows a flow chart of a method 200 according to an embodiment of the invention. Preferably, the method 200 is performed in the system 100. For example, a computer program product can include instructions that cause a processor to perform the steps of the method 200. Method 200 includes the following steps:

Receiving, in step 210, an input that a user makes with a keyboard connected to a computer device. The input causes a predetermined event to occur in the computer device. For example, the system 100 can receive an input that the user 150 makes by depressing one of the keys 180 on the computer keyboard 110. The input may cause a predetermined event to occur, such as an error or the state corresponding to the system receiving user input for an input field that is blocked from receiving the input.

Making, in step 220, a predetermined electronic output from the computer device upon the predetermined event. The predetermined electronic output provides a tactile feedback to the user through the keyboard. For example, the computer device 120 may make a predetermined electronic output through the cable 130, or through the cable 195, upon the predetermined event. Also, the device 190 may provide tactile feedback to the user 150 through the keyboard 110.

FIG. 3 is a block diagram of a system 300 that can be used for providing tactile feedback through a computer keyboard. For example, the system 300 may be included in the system 100 shown in FIG. 1. The keyboard 110 is connected to the computer device 120 through an input/output (I/O) module 310. This allows the keyboard to receive the predetermined electronic output from the computer device. The I/O module 310 is connected to a bus 320 in the keyboard. The keyboard further comprises a processor 330, a Random Access Memory (RAM) 340 and a code storage 350. Essentially, the processor 330 can execute code stored in the code storage 350 and, when necessary, information can be stored in the RAM 340. An electromechanical device 360 is connected to the bus 320 such that the processor 330 can actuate the device 360. For example, upon the computer device sending the predetermined electronic output to the keyboard, the keyboard processor 330 can initiate the device 360 to provide tactile feedback. For example, the device 360 may be a vibrating device. Besides hardware for providing the tactile feedback, the device 360 may include a suitable driver, amplifier, or other such device, that appropriately strengthens the signal from the keyboard processor.

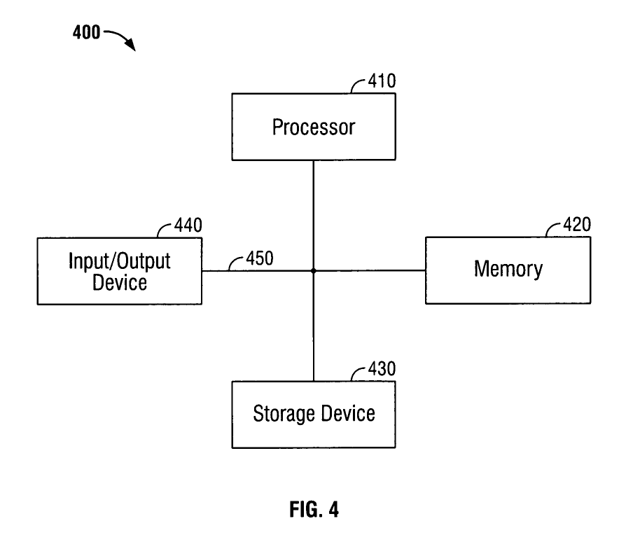

FIG. 4 is a block diagram of a computer system 400 that can be used in the operations described above, according to one embodiment. The system 400 includes a processor 410, a memory 420, a storage device 430 and an input/output device 440. Each of the components 410, 420, 430 and 440 are interconnected using a system bus 450. The processor 410 is capable of processing instructions for execution within the system 400. In one embodiment, the processor 410 is a single-threaded processor. In another embodiment, the processor 410 is a multi-threaded processor. The processor 410 is capable of processing instructions stored in the memory 420 or on the storage device 430 to display graphical information for a user interface on the input/output device 440.

The memory 420 stores information within the system 400. In one embodiment, the memory 420 is a computer-readable medium. In one embodiment, the memory 420 is a volatile memory unit. In another embodiment, the memory 420 is a non-volatile memory unit.

The storage device 430 is capable of providing mass storage for the system 400. In one embodiment, the storage device 430 is a computer-readable medium. In various different embodiments, the storage device 430 may be a floppy disk device, a hard disk device, an optical disk device, or a tape device.

The input/output device 440 provides input/output operations for the system 400. In one embodiment, the input/output device 440 includes a keyboard and/or pointing device. In one embodiment, the input/output device 440 includes a display unit for displaying GUIs as discussed above.

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, any of the described cable connections may be a wireless connection. Accordingly, other embodiments are within the scope of the following claims.

1. A method of providing tactile feedback to a user of a computer device, the method comprising:
receiving an input that a user makes with a keyboard connected to a computer device, the input causing a predetermined event to occur in the computer device; and
making a predetermined electronic output from the computer device upon the predetermined event, the predetermined electronic output providing a tactile feedback to the user through the keyboard.

2. The method of claim 1, further comprising selecting the predetermined electronic output to provide a specific intensity to the tactile feedback.

3. The method of claim 1, wherein the predetermined event is one selected from the group consisting of: an error in the computer device, the user attempting to type more characters than allowed in an input field, the user typing an improper type of character in the input field, the user depressing a key on the keyboard, and combinations thereof.

4. The method of claim 1, wherein the predetermined electronic output is provided in a cable for input from the keyboard to the computer device.

5. The method of claim 4, wherein the keyboard and a device providing the tactile feedback are identified to the computer device as one selected from the group consisting of: a single device and separate devices.

6. The method of claim 1, wherein the predetermined electronic output is provided in a separate cable from a cable for input from the keyboard to the computer device.

7. The method of claim 1, wherein the tactile feedback is provided by a device selected from the following group adjacent the keyboard: a motor, an oscillator, a linear actuator, an agitator, and combinations thereof.

8. The method of claim 6, wherein the device is located in a location selected from the group consisting of: on top of the keyboard, underneath the keyboard, on a side of the keyboard, inside the keyboard, abutting a housing of the keyboard, and combinations thereof.

9. The method of claim 6, wherein the keyboard is a conventional computer keyboard provided with the device.

10. The method of claim 1, wherein the tactile feedback comprises an action selected from the group consisting of: bumping the keyboard, shaking the keyboard, vibrating the keyboard, and combinations thereof.

11. The method of claim 1, wherein the predetermined electronic output is made according to an executable instruction included in a computer keyboard driver application in the computer device, the computer keyboard driver application managing input from the keyboard to the computer device.

12. The method of claim 1, wherein the predetermined electronic output is made according to an executable instruction included in an application other than a computer keyboard driver application that manages input from the keyboard to the computer device.

13. A computer keyboard comprising:
a housing having a plurality of keys with which a user can make an input when the computer keyboard is connected to a computer device; and
a device adjacent the housing for providing a tactile feedback to the user upon a predetermined electronic output from the computer device.

14. The computer keyboard of claim 13, wherein the predetermined electronic output is provided in a cable for input from the keyboard to the computer device.

15. The computer keyboard of claim 13, wherein the predetermined electronic output is provided in a separate cable from a cable for input from the keyboard to the computer device.

16. The computer keyboard of claim 13, wherein the device is one selected from the following group: a motor, an oscillator, a linear actuator, an agitator, and combinations thereof.

17. The computer keyboard of claim 13, wherein the device is located in a location selected from the group consisting of: on top of the housing, underneath the housing, on a side of the housing, inside the housing, abutting the housing, and combinations thereof.

18. The computer keyboard of claim 13, wherein the computer keyboard is a conventional computer keyboard provided with the device.

19. The computer keyboard of claim 13, wherein the device performs an action selected from the group consisting of: bumping the housing, shaking the housing, vibrating the housing, and combinations thereof.

20. The computer keyboard of claim 13, wherein the predetermined electronic output is made according to an executable instruction included in a computer keyboard driver application in the computer device, the computer keyboard driver application managing input from the computer keyboard to the computer device.

21. The computer keyboard of claim 13, wherein the predetermined electronic output is made according to an executable instruction included in an application other than a computer keyboard driver application that manages input from the computer keyboard to the computer device.

22. A computer program product tangibly embodied in an information carrier, the computer program product including instructions that, when executed, cause a processor to perform operations comprising:
receive an input that a user makes with a keyboard connected to a computer device, the input causing a predetermined event to occur in the computer device; and
make a predetermined electronic output from the computer device upon the predetermined event, the predetermined electronic output providing a tactile feedback to the user through the keyboard.

23. The computer program product of claim 22, separate from a computer keyboard driver application that manages keyboard input to the computer device.
